(19) United States
(12) Patent Application Publication
(10) Pub. No.: US 2026/0339748 A1
(43) Pub. Date: Oct. 29, 2026

(54) SELECTING A DEVICE SUITABLE FOR HOSTING AT LEAST ONE PROCESS OF AN APPLICATION AMONG A PLURALITY OF DEVICES OF A COMMUNICATION INFRASTRUCTURE, THE APPLICATION BEING INSTANTIATED FROM THE AT LEAST ONE PROCESS

(71) Applicant: Orange, Issy-les-Moulineaux (FR)

(72) Inventors: Ilhem Fajjari, Chatillon (FR); Baudouin Herlicq, Chatillon (FR)

(21) Appl. No.: 19/116,249

(22) PCT Filed: Sep. 19, 2023
(86) PCT No.: PCT/EP2023/075726

§ 371 Date: Mar. 27, 2025

(30) Foreign Application Priority Data
Sep. 28, 2022 (FR) FR2209826

(51) Int. Cl. G06F 9/50; G06F 9/455; H04L 67/1001

(52) U.S. Cl. CPC G06F 9/5083; G06F 9/45558; H04L 67/1001; G06F 2009/45595

(57) ABSTRACT

A method is described for selecting a device suitable for hosting at least one process of an application among a plurality of devices of a communication infrastructure, the application being instantiated from the at least one process. The method is implemented by an entity for managing the topology of the infrastructure, suitable for managing resources of the devices of the plurality of devices. The method includes receiving from a client entity a request to use the application, obtaining a parameter associated with the at least one process and a location datum of the client entity, selecting the device among the plurality devices, of which a position in the infrastructure is at a required distance with respect to the location datum of the client entity obtained, the selected device further comprising a resource making it possible to satisfy the parameter obtained.

### 1. TECHNICAL FIELD

The invention is implemented in a communication network, such as a telecommunication network capable of conveying communication data from and to fixed or mobile terminals. More precisely, the invention aims to dynamically select one or more devices capable of hosting an application intended to be used by a client entity.

### 2. PRIOR ART

According to known techniques, applications are installed in a permanent and fixed fashion on devices of a communication network and naming information of DNS or URI type allows a device and an application installed on a device to be identified and reached (DNS standing for Domain Name System and URI standing for Uniform Resource Identifier). The devices may be physical devices or virtualized instances such as virtual machines. The development of network virtualization and the implementation of distributed architectures, in particular based on solutions of MEC type (MEC standing for Mobile Edge Computing), aiming to deploy storage and compute infrastructure in the immediate vicinity of users is increasingly common. Furthermore, such storage and compute infrastructure is limited in terms of resources and the users are themselves connected in various locations requiring applications to be deployed in a multitude of compute and storage infrastructures. In prior-art techniques, this development of edge computing is most often adapted to the deployment of CDNs (CDN standing for Content Delivery Network) allowing content to be hosted statically (caches), on geo-distributed PoPs (PoP standing for Point of Presence). Such architectures are sub-optimal because, on the one hand, it is necessary to replicate content and applications on a plurality or even all of the PoPs, so as to satisfy, by guaranteeing a good quality of experience, the various clients wishing to access the application and content, and this method is therefore expensive in terms of resources and not well suited to increasing evolution of the applications and content to which clients want access independently of their location or even while they are on the move. On-demand instantiation services making it possible to avoid static installation and configuration of applications are gradually appearing, in particular among content-hosting entities, but these offerings, although more dynamic, are tied to content and do not make it possible to meet needs on-demand using a geo-distributed infrastructure and in particular do not make it possible to address new types of applications, such as for example gaming applications played on the move, for example while in a vehicle. Existing solutions therefore do not make it possible to manage, in particular in an economical manner, access resources of a communication network comprising application-hosting devices, these resources being limited since they are deployed at the edge of a network infrastructure, while guaranteeing the user of an application an optimal quality of service independent of his or her location. Moreover, prior-art solutions are quite expensive when an application needs to be deployed or updated, because of the multitude of PoPs to be updated, generally simultaneously, to ensure satisfactory access to a plurality of users.

The present invention aims to provide improvements with respect to the prior art.

### 3. SUMMARY OF INVENTION

The invention improves the situation by means of a method for selecting a device suitable for hosting at least one process of an application from a plurality of devices of a communication infrastructure, the application being instantiated using the at least one process, the method being implemented by a management entity managing the topology of the infrastructure, configured to manage resources of the devices of the plurality, and comprising:
receiving a request to use the application from a client entity,
obtaining a parameter associated with the at least one process and a location datum of the client entity,
selecting the device from the plurality the position of which in the infrastructure is at a required distance from the obtained location datum of the client entity, the selected device further comprising a resource allowing the obtained parameter to be satisfied.

The selecting method is novel and inventive since it makes it possible to dynamically use an application, comprising at least one process or executed using at least one process, on one or more selected devices identified as a hosting device. This allows a client to use the application, such as a data service (audio, video, text, etc.), while guaranteeing compliance with constraints associated with the application. In particular, by guaranteeing that the one or more selected devices comply with at least one parameter and also that the device is located within a required maximum distance from the client entity, selection of a suitable device makes it possible to guarantee that the client who requested to use the application receives a satisfactory client experience, and also to economize use of infrastructure resources. The method is particularly relevant for applications or services requiring a low latency, in which case the position of the device, in proximity to the client entity, and the characteristic or parameter of the service, QoS for example, make it possible to satisfy a latency requirement specific to the requested service. The method is particularly relevant because it makes it possible to deploy an application by selecting one device for each of the processes required to instantiate the application, each process potentially having distinct parameters and being able to be hosted relatively far from a client entity. Thus, certain processes of an application will potentially be installed in proximity to a client entity (for example in an MEC architecture, MEC standing for Mobile Edge Computing) while other processes of the application will potentially be installed at the core of the network of the infrastructure. An infrastructure device may independently correspond to a physical device (server, network equipment) or to a virtual machine. The expression “client entity” has a fairly broad meaning since it may be a client terminal (PC, smartphone, set-top box, etc.) but the usage request may also be obtained from an infrastructure administration entity, for example to instantiate a network application (also known as a network service) in the infrastructure. For example, it may be a question of instantiating a new routing protocol in a network infrastructure or a function optimizing a service providing web access.

According to one aspect of the invention, the method further comprises instantiating the at least one process on the selected device.

In the case for example where a process of the application (or all the processes of the application) is (are) not deployed on a device allowing the obtained parameters to be satisfied and/or the device hosting the application is not sufficiently close to the client entity, or the process is not yet deployed in the infrastructure, the management entity may advantageously instantiate, directly or via another infrastructure entity, the process on a device so as to meet the specified requirements (parameters, location). Furthermore, the method makes it possible to better adjust use of infrastructure resources by deploying applications on demand and thus limiting use of resources of infrastructure devices.

According to one particular feature of this embodiment, the selecting method further comprises sending to the client entity an instruction for the client entity to be put on hold for a time corresponding to the time to instantiation of the at least one process on the selected device.

When instantiation of a process or application on a selected device is required, the terminal or client entity that requested to use the application or process is put on hold, and hence the client entity will not try to use the application updated with the process or application to be instantiated when it is not yet available, and hence the client entity will not end up failing. Putting the terminal or client entity on hold in this way thus improves the quality of experience received by the client entity. At least one infrastructure entity or device thus comprises a hardware or software component allowing a client entity to be put on hold before the actual instantiation of the application or process on a hosting device.

According to another aspect of the invention, in the selecting method, the parameter associated with the at least one process belongs to the group comprising:
a datum relating to a resource required for storage of the at least one process in the device,
a datum relating to a processing capacity required for operation of the at least one process,
a datum representative of the maximum latency permitted between the device to be selected and the client entity,
a quality-of-service datum relating to the at least one process.

The selecting method may advantageously be implemented taking one or more parameters into account. In particular, capacity parameters of the device, in terms of CPU (CPU standing for Central Processing Unit) and/or GPU (GPU standing for Graphics Processing Unit), may be taken into account to quantify the resources that the device or devices to be selected must have. Parameters relating to the process, and in particular related to latency and quality of service (transit time, bandwidth, compliance with protocol data), may be taken into consideration when selecting the device.

According to another aspect of the invention, the selecting method further comprises sending to the client entity an identification datum of the selected device.

Once the device has been selected, and possibly once a process has been instantiated on the selected device, the management entity transmits, to the client entity that sent the usage request, a datum identifying the selected device, such as DNS information (DNS standing for Domain Name System) or information of URI type (URI standing for Uniform Resource Identifier), allowing the client entity to for example reach the device and therefore the process or even the application directly.

According to another aspect of the invention, in the selecting method, the management entity managing the topology of the infrastructure uses a directed weighted graph comprising the plurality of devices of the infrastructure to select the device from the plurality.

The management entity may advantageously use a directed weighted graph to improve its knowledge of the separation of a device from the client entity and thus consider a distance that not only reflects a geographical and/or topological separation, but also reflects link capacities between devices and/or device processing capacities.

According to one particular feature of this embodiment, in the selecting method, selecting the device from the plurality comprises:
determining a set of devices from the plurality comprising devices the distance of which from the client entity is less than a reference value computed from the location datum, and
selecting the device from the determined set of devices, said device comprising resources capable of satisfying the parameter.

The method may comprise a step of selecting a set of devices from the plurality, the set being located within a required maximum distance from the client entity, this maximum distance being determined in light of a reference value for example determined by the operator of the infrastructure and making it possible to guarantee that a maximum quality-of-service level and/or a maximum hop count is respected by the device to be selected for the one or more processes of the application. Selecting a device in two stages like this makes it possible, initially, to consider only eligible devices and, subsequently, to analyze the hardware and software resources (memory, CPU, processing capacity, etc.) of only these eligible devices, safe in the knowledge that ineligible devices, even if they had sufficient resources, could not be selected due to their separation from the client entity.

According to one particular feature of this embodiment, in the selecting method, the reference value corresponds to a number of hops between a device to be selected and the client entity, and/or to a geographical distance between the device to be selected and the client entity, and/or to a distance between the device to be selected and the client entity taking into account a weighting of at least one link and/or of at least one function of the infrastructure positioned between the client entity and the device to be selected in the weighted graph.

A reference value representing the distance between the client entity and the device to be selected may be represented by a variety of parameters used individually or in combination. Thus, a number of hops between the client entity and the device to be selected, corresponding for example to a number of functions, illustrates the topology of the infrastructure. A geographical distance may be relevant if, for example, the infrastructure is centralized and the number of hops provides little information on distance. Taking a weighting into account makes it possible to obtain improved “distance” information since a link or function of the infrastructure (routing equipment (which may potentially be virtualized), router, switch, etc.)) having greater capacities may be more suitable than a device that is nearer from a topological point of view but the lesser capacities of which are less advantageous for guaranteeing a quality-of-service level for the process and therefore for the client entity, for example.

According to one particular feature of this embodiment, in the selecting method, the method comprises at least one incrementation of the reference value up to a maximum reference value in the case where no device is selected and, for each incrementation, a determining step and a selecting step, according to the embodiment described above.

In the case where no device is sufficiently close to the client entity, considering the various types of possible reference values, the reference value may be incrementally increased up to a maximum value, beyond which it is no longer possible to guarantee a sufficiently satisfactory quality of experience for the process and client entity or beyond which a permitted deployment limit of the application in the infrastructure is exceeded. If the maximum value is reached, the process cannot thus be used and/or instantiated on any infrastructure device.

According to one aspect of the invention, in the selecting method, a single device is selected for a set of processes required for instantiation of the application, the obtained parameter relating to the set of processes.

In the case where a plurality of processes of an application, or even all the processes of an application, must be deployed on a single device, for example to guarantee better interaction between the processes, or to guarantee ease of management of the applications, or to limit the complexity of identifying or even resolving problems in implementing an application, a single infrastructure device may advantageously be selected. Selection may then be based on obtaining a parameter relating to the application or to all the processes in question to determine the suitable device.

The various aspects of the selecting method that have just been described may be implemented independently of one another or in combination with one another.

The invention also relates to a device for selecting a device suitable for hosting at least one process of an application from a plurality of devices of a communication infrastructure, the application being instantiated using the at least one process, characterized in that the device is configured to:
receive a request to use the application from a client entity,
obtain a parameter associated with the at least one process and a location datum of the client entity,
select the device from the plurality the position of which in the infrastructure is at a required distance from the obtained location datum of the client entity, the selected device further comprising a resource allowing the obtained parameter to be satisfied.

The selecting device is able, in all of its embodiments, to implement the selecting method that has just been described.

The invention also relates to a system for selecting at least one device suitable for hosting at least one process of an application from a plurality of devices of a communication infrastructure, the application being instantiated using the at least one process, characterized in that the system comprises a selecting device such as described above and a client entity configured to send the request to use the application to the selecting device. The invention also relates to a computer program comprising instructions for implementing the steps of the selecting method that has just been described when this program is executed by a processor and to a recording medium able to be read by a selecting device and on which the computer program is recorded.

The aforementioned program may use any programming language and take the form of source code, object code, or intermediate code between source code and object code, such as code in a partially compiled form, or in any other desirable form.

The abovementioned information media may be any entity or device capable of storing the program. For example, a medium may include a storage means, such as a ROM, for example a CD-ROM or a microelectronic circuit ROM, or else a magnetic recording means.

Such a storage means may be for example a hard disk, a flash memory, etc.

Moreover, an information medium may be a transmissible medium such as an electrical or optical signal, which may be routed via an electrical or optical cable, by radio or by other means. A program according to the invention may in particular be downloaded from a network such as the Internet.

Alternatively, an information medium may be an integrated circuit in which a program is incorporated, the circuit being designed to execute or to be used in the execution of the method in question.

### 4. BRIEF DESCRIPTION OF THE DRAWINGS

Other features and advantages of the invention will become more clearly apparent on reading the following description of particular embodiments, which are given by way of mere illustrative and non-limiting examples, and the appended drawings, in which:

FIG. 1 shows a network infrastructure in which the selecting method is implemented according to one aspect of the invention,

FIG. 2 illustrates one implementation of the selecting method, according to one embodiment of the invention,

FIG. 3 illustrates one implementation of the selecting method, according to another embodiment of the invention,

FIG. 4 illustrates a selecting device, according to one embodiment of the invention.

### 5. DESCRIPTION OF EMBODIMENTS

In the remainder of the description, embodiments of the invention are presented in the context of a communication infrastructure. The expressions “communication infrastructure” and “communication network” may be used interchangeably in the embodiments of the invention. This communication infrastructure may be used to route communication data to fixed or mobile terminals, and the infrastructure may be implemented using physical equipment and/or virtualized functions. The infrastructure may be used to route and/or process data of residential or business customers and of fixed or mobile users, and may be operated by a telecommunications operator.

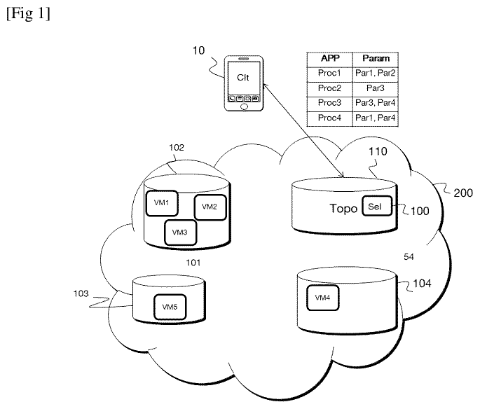

Reference will first be made to [FIG. 1], which shows a communication infrastructure in which the selecting method is implemented according to one aspect of the invention.

In a communication infrastructure 200, a management entity 110 managing the topology of the infrastructure 200 manages the various resources 102, 103, 104, VM1, VM2, VM3, VM4, VM5 of the infrastructure 200. This management entity 110, also known as the topology server, thus maintains a database containing information on the various devices or resources 102, 103, 104, VM1, VM2, VM3, VM4, VM5 and on the applications and processes Proc1, Proc2, Proc3 and Proc4 instantiated and instantiable on these devices. A device according to the invention may be a physical equipment 102, 103, 104 or a virtual instance such as a virtual machine VM1, VM2, VM3, VM4 and VM5 or even a container, according to another example. The virtual machine VM1 thus corresponds to the virtual machine VM1 on the physical equipment 102. A process is considered instantiable on a device if its dependencies are installed, if images of containers of components comprising one or more processes are available on the device, and if the device is permitted, for example by the infrastructure manager or resource manager, to host this process. The management entity 110 comprises a selecting device 100 (Sel) that executes selection operations with a view to identifying a device of the infrastructure 200 already hosting a required process or to identify a device on which a process required by a client entity 10 (Clt) will be instantiated. This selection can be made using a directed weighted graph comprising all of the devices 102, 103, 104, VM1, VM2, VM3, VM4, VM5 of the infrastructure 200 to select the device capable of hosting the process in accordance with the usage request received from the client entity 10. The client entity 10 may be a user terminal such as a smartphone, PC, residential gateway or any other device that a user is able to employ to execute or use an application. The client entity Clt may also be an administration entity of the communication infrastructure, for example responsible for deploying network services on demand, and therefore dynamically. The application may be a value-added application, such as a voice, video and/or data service for example involving a server or a terminal not shown in [FIG. 1]. An application may be instantiated using one or more processes, a process being characterized by an ordered sequence of operations leading to a result. Thus, in [FIG. 1], the application requested by the client entity 10 from the management entity 110 comprises four processes Proc1, Proc2, Proc3 and Proc4, these processes possibly being processes relating to network operations and/or operations of application type. According to one example, it may be an operation leading to discovery of a server, connection to a server, receipt of an application flow, or processing of an application flow. Each process Proc1, Proc2, Proc3, and Proc4 of the application is characterized by a set of parameters. To give a non-exhaustive list of these parameters, a parameter may be:
a datum relating to the resources required to store the at least one process in the device 102, 103, 104, VM1, VM2, VM3, VM4, VM5, this datum potentially corresponding, for example, to a number of bytes in the resource,
a datum relating to the processing capacities required for operation of the at least one process Proc1, Proc2, Proc3 and Proc4, this datum potentially being illustrated by a CPU or GPU capacity of the resource (CPU standing for Central Processing Unit),
a datum representative of the maximum latency permitted between the device to be determined and the client entity, this datum potentially being represented, for example, by a number of milliseconds taken to route a packet between the client entity and the device, this datum potentially corresponding to the result of a network tool such as a ping or traceroute,
a quality-of-service datum relating to the process Proc1, Proc2, Proc3 and Proc4 for which a device 102, 103, 104, VM1, VM2, VM3, VM4, VM5 is selected, this datum potentially being represented by a (standard, silver, gold) quality-of-service level or by guarantees made in respect of routing a data flow of a typical application.

Each application therefore comprises one or more processes, such as the processes Proc1, Proc2, Proc3 and Proc4, each process being characterized by a certain number of constraints or parameters, such as a minimum amount of CPU/memory resources, use of a GPU (GPU standing for Graphics Processing Unit), and maximum latency permitted between the instantiated application and the user, in particular in order to guarantee the user of the client entity 10 an experience of optimal quality. The management entity 110 uses these parameters or constraints and the location of the client entity to determine the most suitable device for the client entity to use for the application. Thus, in the case where a process is already instantiated in the infrastructure 200, the management entity 110 must determine whether the location of this device is suitable for execution of the application by the client entity that transmitted the request and whether, furthermore, the process is being implemented in compliance with the identified parameters. Specifically, according to one alternative, the parameters may be related to the various processes Proc1, Proc2, Proc3 and Proc4 of the application but also to the type of client entity 10, given for example that quality-of-service parameters differ depending for example on whether or not the client entity is a terminal able to accommodate a very high bandwidth, for example. According to one example, the client entity 10 may be an administration station of the communication infrastructure 200 and the selecting method is used to select and possibly instantiate a network service of the type enabling access, routing, address translation or protocol conversion in the communication infrastructure 200.

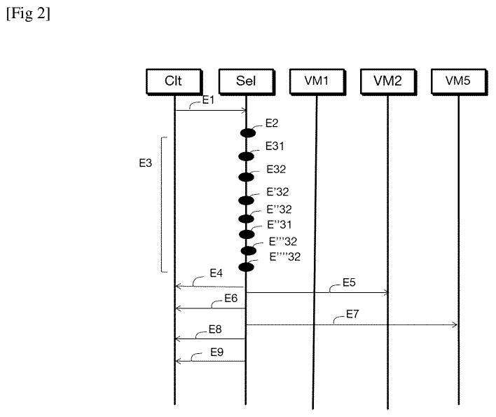

Reference will now be made to [FIG. 2], which illustrates one implementation of the selecting method, according to one embodiment of the invention.

The entities shown in [FIG. 2] have the same features as the entities having the same name in [FIG. 1].

In a step E1, the client entity Clt sends a request Req to use an application to the management entity managing the topology of a communication infrastructure comprising a selecting device Sel. The request may for example contain a FQDN request to obtain use of an application (FQDN standing for Fully Qualified Domain Name). The client entity Clt will have been authenticated beforehand, in particular in order to verify that it is actually able to use the requested application, and it will also have obtained the address of the management entity, for example when it connects to a communication infrastructure or via static configuration, for example in the case where the client entity is an infrastructure administration platform. The usage request may be transmitted directly or indirectly, for example via an application management platform, to the management entity and therefore to the selecting device comprised in the management entity. The selecting device Sel having received this request determines and selects the one or more devices hosting or capable of hosting the application or a process of the application.

In an optional step, the selecting device Sel identifies the processes related to the application. This step may be performed using a database, which may or may not be supported by the selecting device Sel, or else it may be performed by the service platform in the case where the usage request of the client entity is routed via this platform. In this case, the platform will transmit the request and the processes associated with the requested application. According to another example, the client entity transmits the usage request containing identifiers of processes associated with the requested application. According to another example, the application comprises a single process and this identification is not necessary. The process is represented by the application requested by the client entity. In this example, it is considered that the application of which use is required comprises four processes Proc1, Proc2, Proc3, and Proc4.

In a step E2, the selecting device Sel obtains one or more parameters associated with each process identified in the previous step or with the application, in the case for example where the application is a single-process application. The one or more parameters may be obtained by way of a database internal to the topology management entity, allowing a process to be characterized by one or more parameters such as those illustrated in [FIG. 1]. They may also be obtained via another entity able to identify the parameters associated with a process. According to this example, the selecting device will send a request containing an identifier of the process to an entity managing the processes and will receive in return the parameters associated with the process. According to one example, the service platform indicated in the description of step E1 above may also transmit the parameters associated with the processes. In the embodiment of [FIG. 2], in conjunction with [FIG. 1], the parameters Par1 and Par2 are obtained for the process Proc1, the parameter Par3 for the process Proc2, the parameters Par3 and Par4 for the process Proc3 and the parameters Par1 and Par4 for the process Proc4.

In a step E3, the selecting device Sel selects one or more devices of the communication infrastructure, this or these devices needing to be positioned as a function of a required distance between the selected device and the client entity Clt. The one or more selected devices must further comprise resources allowing the parameters obtained previously and corresponding to each process to be satisfied. The selecting device must select one device for each process Proc1, Proc2, Proc3 and Proc4, the devices selected for each process potentially being separate or not. The device selected for the process Proc1 must comprise resources capable of satisfying the parameters Par1 and Par2, the device selected for the process Proc2 must comprise resources capable of satisfying the parameter Par3, the device selected for the process Proc3 must comprise resources capable of satisfying the parameters Par3 and Par4, the device selected for the process Proc4 must comprise resources capable of satisfying the parameters Par1 and Par4. To select the hosting devices, the selecting device Sel uses the location of the client entity, which location may be topological and/or geographical. Information on the location of the client entity, which may be an IP address and/or a GPS coordinate or any other datum providing information on the location of the client entity, is for example transmitted when the usage request transmitted by the client entity Clt is sent or it may be obtained by the selecting device in a parameter used during connection of the client entity to the communication infrastructure. This location datum of the client entity is taken into account by the selecting device to deploy, for example, applications in architectures of MEC type (MEC standing for Mobile Edge Computing) and/or to ensure a balanced distribution of the processes used by client entities between the various infrastructure devices. The selecting device, for example using its database on the processes deployed in the various devices and/or on the resources available on the devices capable of hosting one or more processes, selects one or more devices VM1, VM2 and VM5 associated with each process and the distance of which from the client entity Clt is for example less than a reference value (which is for example specific to a process and/or to the infrastructure) determined by the selecting device.

According to one example, this selecting step E3 comprises a number of sub-steps. The following steps are performed to select a device for the process Proc1, but these steps are identical for selecting a device for the other processes Proc2, Proc3 and Proc4, given that different selections can be carried out iteratively or in parallel for the different processes.

In a step E31, the selecting device Sel determines a set of devices from the plurality, this set comprising devices positioned at a distance less than a reference value based on a location datum of the client entity Clt. This reference value for example represents a number of hops in the infrastructure between a potentially selected hosting device of the infrastructure and the client entity, and/or at a geographical distance between the potentially selected device and the client entity, and/or at a distance between the potentially selected device and the client entity taking into account a weighting of at least one link and/or of at least one function (equipment, router, switch, etc.) positioned between the client entity and the device to be selected, obtained for example from a directed weighted graph such as described above. The number of hops for example corresponds to a number of functions employed to route a packet of a process between the client entity Clt and a potentially selected device.

According to one example, the set of devices determined to be valid with respect to the reference value contains the devices VM1, VM2, VM3, VM4 as shown in FIG. 1. Given that only the location datum of the client entity Clt is taken into account to define this set, these devices of the set are in principle selectable for the various processes Proc1, Proc2, Proc3 and Proc4.

The selecting device Sel then selects, in a step E32, from these preselected devices VM1, VM2, VM3, VM4 alone, the device comprising resources capable of satisfying the parameters Par1 and Par2 of the process Proc1. The selecting device Sel determines whether one or more devices from the devices VM1, VM2, VM3, VM4 is/are already hosting the process in compliance with the parameters Par1 and Par2. If so, the selecting device Sel selects it. If more than one device is hosting the process, the selecting device Sel chooses one of these devices, either depending on the distance of the device to be selected to the client entity Clt, or for example depending on the storage or computing capacities of the device. The selecting device Sel, in this example, selects the device or virtual machine VM1 in step E32.

In a step E4, according to one alternative, the selecting device Sel informs the client entity Clt about the device VM1 selected for the process Proc1. This step may be carried out immediately after step E32 or after step E3 has completely finished. According to another option, the selecting device transmits a message including the various devices instantiating the various processes Proc1, Proc2, Proc3 and Proc4 once a device has actually been selected for each process of the application, thus avoiding sending one message to inform the client entity Clt about each process, the client entity only being informed when the application, and therefore all the processes required for instantiation of the application, can actually be instantiated in the communication infrastructure.

This selecting step E32 is reiterated for the other processes Proc2, Proc3 and Proc4. If, in step E32, no device is hosting a required process, then the selecting device Sel instantiates the process on a device with the resources required to satisfy the parameters associated with the process. By way of example, the selecting device Sel does not identify any device among the devices VM1, VM2, VM3, VM4 instantiating the process Proc2 and determines, in step E′32, that the device VM2 has the resources to instantiate the process Proc2. In a step E5, the selecting device instantiates the process Proc2 on the device or virtual machine VM2. This instantiation may be performed directly by the selecting device Sel or via another entity of the infrastructure, such as a device configuration entity. According to one alternative, in a step E6, the selecting device Sel transmits to the client entity Clt a put-on-hold message, to indicate thereto that the process is being instantiated. According to another alternative, the put-on-hold message relates to the requested application and the message is sent to the client entity Clt when one or more of the processes Proc1, Proc2, Proc3, Proc4 of the application must be instantiated on a hosting device. Thus, according to this alternative, the client entity Clt receives a put-on-hold message directly related to the initially transmitted usage request. Putting the client entity on hold corresponds, for example, to the transmission of information on a “waiting room”, corresponding to a component installed on a hosting device VM1, VM2, VM3, VM4 or on the management entity 110 or even on a specific device (not shown), which redirects the client entity to the installed process once it has been actually installed. In the case where the process is already hosted on a device, it is not necessary to send the hold instruction and to use the waiting room on the device unless the process is in standby mode or inoperative for a period of time. In the case where the hold message relates to the requested application, the waiting room is advantageously implemented in one of the devices hosting one of the processes, and by way of example in a device comprising a process for managing resources relating to the application. This device, whether it is a hosting device VM1, VM2, VM3, VM4, the management entity 110 or a specific device assigned to this role, must thus be informed of the actual instantiation of all of the processes required for instantiation of the application, in order to redirect the client entity Clt, for example through implementation of an http redirection or through use of an FQDN associated with the application.

Steps E5 and E6 may be performed directly after step E'32 or after step E3 has ended for all of the processes Proc1, Proc2, Proc3 and Proc4 as shown in FIG. 2.

In a step E″32 of step E3, aimed at determining a device instantiating or, failing that, capable of instantiating the process Proc3 in compliance with the parameters Par3 and Par4, the selecting device does not identify such a device among the devices VM1, VM2, VM3, VM4. In this case, the reference value used to define a set of devices capable of hosting a process of the application is incremented in a step E″31. The incrementation may consist in adding one or more hops and/or increasing the geographical distance from the client entity Clt. In this example, the set of eligible hosting devices in addition contains the device VM5, which is now eligible to host one of the processes. The selecting device Sel determines, in a step E″32, that the device VM5 is capable of instantiating the process Proc3 in compliance with the parameters Par4 and Par5. The selecting device Sel instantiates the process Proc3 on the virtual machine VM5 in a step E7 and, according to one alternative, transmits a put-on-hold instruction to the client entity Clt in a step E8. In the case where no device is instantiating or able to instantiate the process Proc3 after the incrementation, step E″31 is reiterated until the reference value reaches a maximum. In this case, the process cannot be instantiated on a device of the infrastructure and the application, in the case where this process is absolutely necessary to operation of the application, cannot be installed in the infrastructure in compliance with the specified requirements. In this case, the selecting device informs the client entity Clt that the application cannot be used by the client and that its request cannot therefore be satisfied. In a step E″″32, the selecting device determines, among the eligible devices, before or after incrementing the reference value, that the device VM1 is instantiating the process Proc4 and selects it. The selecting device may consider only the devices VM1, VM2, VM3 and VM4 when determining the device capable of hosting the process Proc4, or it may further consider the device VM5, depending on whether it performs step E″″32 after step E″31 as in [FIG. 2], or before this step E″31 according to an alternative that has not been shown. The selecting device is indeed able to select every possible process from the set of devices defined by the reference value, or to consider the set that is the largest possible with respect to the reference value to select a device.

According to one alternative, step E3 comprises only one iteration and the selecting device selects the devices for the various processes from a set of devices defined with respect to the location of the client entity without possibility of modifying this set.

In the case where all the processes Proc1, Proc2, Proc3 and Proc4 have actually been instantiated by the selecting device Sel or prior to implementation of the selecting method, the selecting device Sel may advantageously inform, in a step E9, the client entity Clt about the availability of the application in its completeness and possibly inform the client entity about the devices VM1, VM2 and VM5 used to instantiate the processes of the application. This information is particularly relevant in the case where the client entity Clt is an infrastructure administration entity, in which case information on how the processes of an application are being hosted is highly relevant, in particular for managing and identifying incidents or degradation of quality of service.

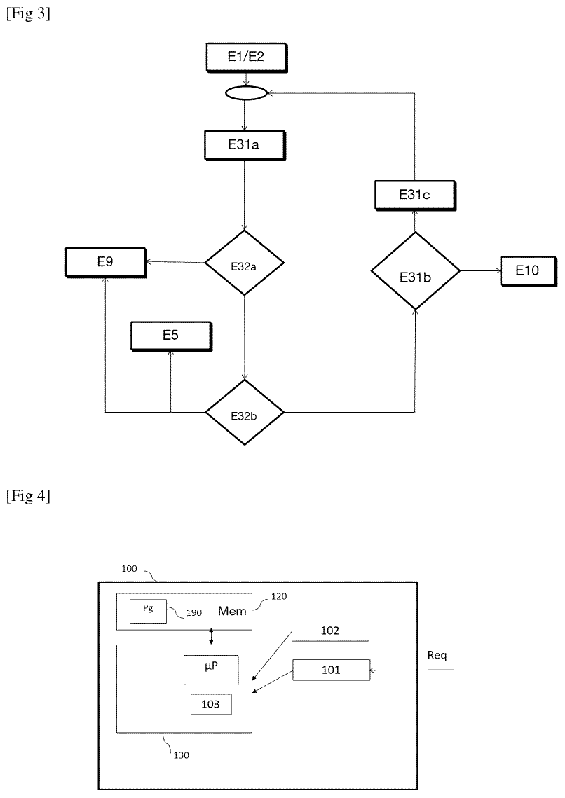

Reference will now be made to [FIG. 3], which illustrates one implementation of the selecting method, according to another embodiment of the invention.

In this embodiment, a device is selected to host an application in accordance with a request from a client entity to use the application. In this embodiment, the application is single-component and the process or processes of the application are hosted on a single device of a communication infrastructure. [FIG. 3] shows the steps implemented by a device for selecting a management entity of the communication infrastructure.

In steps E1 and E2, the device receives a request to use an application from a client entity and obtains a set of parameters relating to this application, in accordance with steps E1 and E2 illustrated in [FIG. 2].

The selecting device, for example using a directed weighted graph or using a database containing the various devices, determines, in a step E31a, a set of devices the distance of which from the client entity is less than a distance N.

In a step E32a, the selecting device evaluates whether a device among the devices determined in step E31a has sufficient resources and has already instantiated the application requested by the client entity, in compliance with the parameters obtained in step E2.

If this is the case, i.e. if a device has been identified in step E32a, the device informs the client entity thereof in a step E9. If no device has instantiated it, the selecting device evaluates, in a step E32b, whether a device selected in step E31a has the resources necessary for the process or processes of the requested application, and consecutively the application itself. If a device is indeed able to act as a host, it is selected, and an identifier (IP address, URI, FQDN identifier) is transmitted to the client entity in a step E9. Furthermore, the application is actually instantiated on the selected device in a step E5.

In the case where no device is selected in step E32b, the device determines, in a step E31b, whether the value N is equal to or greater than a reference value NMax, representative of a maximum acceptable distance for a device required to host the requested application. If the value is equal to or greater than this value N, an error message is returned to the client entity in a step E10 indicating that the client entity cannot use the application or cannot install the application, depending on the client entity in question. In the case where the value N is less than the value NMax, the value N is incremented in a step E31c, this incrementation possibly corresponding to an increase in the number of hops and/or to a larger radius of the domain in which a device is selected. Once the value N has been incremented, step E31a is repeated. Steps E31a, E31b and E31c are sub-steps of step E31 (illustrated in FIG. 2) and steps E32a and E32b are sub-steps of step E32 (illustrated in FIG. 2).

Reference will now be made to FIG. 4, which shows a selecting device 100 according to one embodiment of the invention.

Such a selecting device may be implemented in a management entity, such as the administration entity of a telecommunications network, which is for example instantiated using virtualized functions.

For example, the selecting device 100 comprises a processing unit 130, equipped for example with a microprocessor μP and controlled by a computer program 110, stored in a memory 120 and implementing one of the various embodiments of the selecting method according to the invention. On initialization, the code instructions of the computer program 190 are for example loaded into a RAM memory, before being executed by the processor of the processing unit 130. Such a selecting device 100 comprises a receiving module 101, configured to receive from a client entity a request Req to use the application, an obtaining module 102, configured to obtain a parameter associated with the at least one process and a location datum of the client entity, a module 103 for selecting the device from the plurality the position of which in the infrastructure is at a required distance from the obtained location datum of the client entity, the selected device further comprising a resource allowing the obtained parameter to be satisfied.

Advantageously, the selecting device 100 further comprises a sender, configured to send to the client entity an instruction for the client entity to be put on hold for a time corresponding to the time to instantiation of the at least one process on the selected device. Advantageously, the sender is configured to send to the client entity a datum identifying the selected device.

Advantageously, the selecting device 100 comprises a determining module, configured to determine a set of devices from the plurality comprising devices the distance of which from the client entity is less than a reference value computed from the location datum, and a selecting module, configured to select the device from the determined set of devices, said device comprising resources capable of satisfying the parameter.

The term “module” may correspond equally to a software component or to a hardware component or to a set of software and hardware components, a software component itself corresponding to one or more computer programs or subroutines or, more generally, to any element of a program able to implement a function or a set of functions.

1. A method for selecting a device suitable for hosting at least one process of an application from a plurality of devices of a communication infrastructure, the application being instantiated using the at least one process, the method being implemented by a management entity managing the topology of the infrastructure, configured to manage resources of the devices of the plurality of devices, and comprising:
receiving a request to use the application from a client entity,
obtaining a parameter associated with the at least one process and a location datum of the client entity, and
selecting a device from the plurality of devices, a position of the device in the infrastructure at a required distance from the obtained location datum of the client entity, the selected device further comprising a resource allowing the obtained parameter to be satisfied.

2. The method of claim 1, further comprising instantiating the at least one process on the selected device.

3. The method of claim 2, further comprising sending to the client entity an instruction for the client entity to be put on hold for a time corresponding to the time to instantiation of the at least one process on the selected device.

4. The method of claim 1, wherein the parameter associated with the at least one process belongs to the group comprising:
a datum relating to a resource required for storage of the at least one process in the device,
a datum relating to a processing capacity required for operation of the at least one process,
a datum representative of a maximum latency permitted between the device to be selected and the client entity, and
a quality-of-service datum relating to the at least one process.

5. The method of claim 1, further comprising sending to the client entity an identification datum of the selected device.

6. The method of claim 1, wherein the management entity managing the topology of the infrastructure uses a directed weighted graph comprising the plurality of devices of the infrastructure to select the device from the plurality of devices.

7. The method of claim 6, wherein selecting the device from the plurality of devices comprises:
determining a set of devices from the plurality of devices, the determined set of devices comprising devices a distance of which from the client entity is less than a reference value computed from the location datum, and
selecting the device from the determined set of devices, said device comprising resources capable of satisfying the parameter.

8. The method of claim 7, wherein the reference value corresponds to a number of hops between a device to be selected and the client entity, and/or to a geographical distance between the device to be selected and the client entity, and/or to a distance between the device to be selected and the client entity taking into account a weighting of at least one link and/or of at least one function of the infrastructure positioned between the client entity and the device to be selected in the weighted graph.

9. The method of claim 7, comprising at least one incrementation of the reference value up to a maximum reference value in the case where no device is selected and, for each incrementation, a determining step and a selecting step, as claimed in claim 7.

10. The method of claim 1, wherein a single device is selected for a set of processes required for instantiation of the application, the obtained parameter relating to the set of processes.

11. A device for selecting a device suitable for hosting at least one process of an application from a plurality of devices of a communication infrastructure, the application being instantiated using the at least one process, the device is configured to:
receive a request to use the application from a client entity,
obtain a parameter associated with the at least one process and a location datum of the client entity, and
select the device from the plurality of devices, a position of the device in the infrastructure at a required distance from the obtained location datum of the client entity, the selected device further comprising a resource allowing the obtained parameter to be satisfied.

12. A system for selecting at least one device suitable for hosting at least one process of an application from a plurality of devices of a communication infrastructure, the application being instantiated using the at least one process, the system comprising:
the selecting device of claim 11; and
a client entity configured to send the request to use the application to the selecting device.

13. A computer comprising a processor and a memory, the memory having stored thereon instructions which, when executed by the processor, cause the computer to implement the method of claim 1.

14. A non-transient computer-readable recording medium having stored thereon instructions which, when executed by a processor, cause the processor to implement the method of claim 1.
